(19) United States
(12) Patent Application Publication
(10) Pub. No.: US 2024/0263813 A1
(43) Pub. Date: Aug. 8, 2024

(54) AIR PURIFIER AND OPERATING METHOD THEREOF

(71) Applicant: Samsung Electronics Co., Ltd., Suwon-si (KR)

(72) Inventors: Dongwook KIM, Suwon-si (KR); Jaiyoung CHUNG, Suwon-si (KR); Joonseon JEONG, Suwon-si (KR)

(21) Appl. No.: 18/229,801

(22) Filed: Aug. 3, 2023

(30) Foreign Application Priority Data
Feb. 6, 2023 (KR) 10-2023-0015719

(51) Int. Cl. F24F 8/167; F24F 8/192

(52) U.S. Cl. CPC F24F 8/167; F24F 8/192

(57) ABSTRACT

An air purifier includes a reactor in a tubular shape defining a hollow region extending in a first direction, a first electrode unit extending in the first direction and arranged in the hollow region, a second electrode unit arranged to surround the first electrode unit and separated from the first electrode unit with a certain space therebetween, a power source unit which applies a certain voltage between the first electrode unit and the second electrode unit to generate plasma between the first electrode unit and the second electrode unit, a support arranged between the first electrode unit and the second electrode unit, where a plurality of through-holes extending in the first direction is defined through the support, and a catalyst coated on a surface of the support defining the plurality of through-holes.

### CROSS-REFERENCE TO RELATED APPLICATIONS

This application claims priority to Korean Patent Application No. 10-2023-0015719, filed on Feb. 6, 2023, and all the benefits accruing therefrom under 35 U.S.C. § 119, the content of which in its entirety is herein incorporated by reference.

### BACKGROUND

### 1. Field

The disclosure relates to an air purifier which purifies a pollutant gas containing a pollutant and an operating method of the air purifier.

### 2. Description of the Related Art

An air purifier purifies air by collecting or decomposing gas, for example, fine dust and pollutants in the air. The air purifier may be used in industrial dust collection equipment, an air conditioning/ventilating system in a building, etc.

Recently, as the legal regulations for the atmospheric environment have become more stringent, techniques for treating odorants such as ammonia, hydrogen sulfide, etc., and volatile organic compounds (VOCs) such as toluene and xylene have been actively developed.

Plasma, especially, low-temperature plasma may provide a region of high reactivity at a room temperature by generating various active species such as electrons, ions, radicals, etc. of high energy at a temperature close to a room temperature. In a region of high reactivity using plasma, pollutants including a volatile organic compound may be purified. When plasma and a catalyst are combined, active species generated in the plasma may act on the catalyst, such that a volatile organic compound decomposition catalyst generally working at a high temperatures of 200 degrees or greater may act at a room temperature.

### SUMMARY

Provided are an air purifier including a volatile organic compound decomposition catalyst in which an active specie generated in plasma acts on a catalyst to act at a room temperature, and a method of purifying air.

Provided are an air purifier and a method of purifying air in which an active specie generated in plasma acts on a catalyst for a short time to increase the activation efficiency of the catalyst by the plasma.

Provided are an air purifier and a method of purifying air in which a differential pressure between a front end and a rear end of a plasma reactor is reduced.

Provided are an air purifier and a method of purifying air in which the differential pressure between the front end and the rear end of the plasma reactor is reduced to purify a large flow rate of polluted air.

According to an embodiment of the disclosure, an air purifier includes a reactor in a tubular shape defining a hollow region extending in a first direction, a first electrode unit extending in the first direction and arranged in the hollow region, a second electrode unit arranged to surround the first electrode unit and separated from the first electrode unit with a certain space therebetween, a power source unit which applies a certain voltage between the first electrode unit and the second electrode unit to generate plasma between the first electrode unit and the second electrode unit, a support arranged between the first electrode unit and the second electrode unit, where a plurality of through-holes extending in the first direction is defined through the support, and a catalyst coated on a surface of the support defining the plurality of through-holes.

In an embodiment, the support may have a honeycomb structure.

In an embodiment, a differential pressure between a front end of the reactor and a rear end of the reactor may be greater than or equal to about 10 Pa and less than or equal to about 1,000 Pa.

In an embodiment, the catalyst may include at least one selected from titanium (Ti), aluminum (AI), zinc (Zn), copper (Cu), magnesium (Mg), silicon (Si), nickel (Ni), platinum (Pt), rhodium (Rh), argentum (Ag), ruthenium (Ru), and an oxide thereof.

In an embodiment, the catalyst may include a material having a permittivity greater than or equal to about 3 and less than or equal to about 2,500.

In an embodiment, the catalyst may include a material having an electrical conductivity of about 106 S/cm or less.

In an embodiment, the support may include at least one selected from a metal oxide, a metal nitride, and a high-molecular polymer.

In an embodiment, the reactor and the support may be formed integrally with each other as a single unitary and indivisible part.

In an embodiment, the reactor may have a cross-section in a circular shape along a plane perpendicular to the first direction, and the first electrode unit may be arranged in a center of the circular shape.

In an embodiment, the first electrode unit may include a steel wire arranged in the hollow region of the reactor, and the second electrode unit may include an aluminum plate arranged on an outer wall portion of the reactor.

In an embodiment, the first electrode unit may be provided in plural, and a plurality of first electrode units may be arranged to be separated from each other with a certain space therebetween along a plane perpendicular to the first direction.

In an embodiment, the reactor may has a cross-section in a circular shape along a plane perpendicular to the first direction, and the plurality of first electrode units may be arranged symmetrically with respect to each other around a center of the circular shape.

In an embodiment, the first electrode unit may has a cross-section in a circular shape along a plane perpendicular to the first direction.

In an embodiment, the first electrode unit may has a cross-section in a polygonal shape along a plane perpendicular to the first direction.

In an embodiment, the reactor may has a cross-section in a circular shape along a plane perpendicular to the first direction, and the first electrode unit may be arranged such that the polygonal shape is symmetric around a central portion of the circular shape.

In an embodiment, the air purifier may further include one or more filter units arranged in one or more of the plurality of through-holes, respectively.

According to an embodiment of the disclosure, an operating method of the air purifier includes forming plasma between the first electrode unit and the second electrode unit by applying a certain voltage to the first electrode unit and the second electrode unit, moving polluted air to a reactor in the first direction, removing a pollutant included in the polluted air by using the plasma, and removing the pollutant included in the polluted air by using the catalyst coated on the support.

In an embodiment, the operating method may further include removing the pollutant included in the polluted air by using one or more filter units arranged in one or more of the plurality of through-holes, respectively.

In an embodiment, the support may have a honeycomb structure.

### BRIEF DESCRIPTION OF THE DRAWINGS

The above and other features of certain embodiments of the disclosure will be more apparent from the following description taken in conjunction with the accompanying drawings, in which:

FIG. 1 is a schematic diagram of an air purifier according to an embodiment;

FIG. 2 is a block diagram of an air purifier according to an embodiment;

FIG. 3 is a schematic perspective view of a purification unit according to an embodiment;

FIG. 4 is a front view of the purification unit shown in FIG. 3;

FIG. 5 is an enlarged view of a region M shown in FIG. 4;

FIG. 6 is a front view of a purification unit according to an embodiment;

FIG. 7 is a front view of a purification unit according to an embodiment;

FIG. 8 is a front view of a purification unit according to an embodiment;

FIG. 9 is an enlarged view of a region N shown in FIG. 8; and

FIG. 10 is a flowchart of an air purifying method according to an embodiment.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. Expressions such as “at least one of” or “at least one selected from,” when preceding a list of elements, modify the entire list of elements and do not modify the individual elements of the list. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within +30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the disclosure will be described with reference to the accompanying drawings. In the drawings, like reference numerals denote like components, and sizes of components in the drawings may be exaggerated for convenience of explanation.

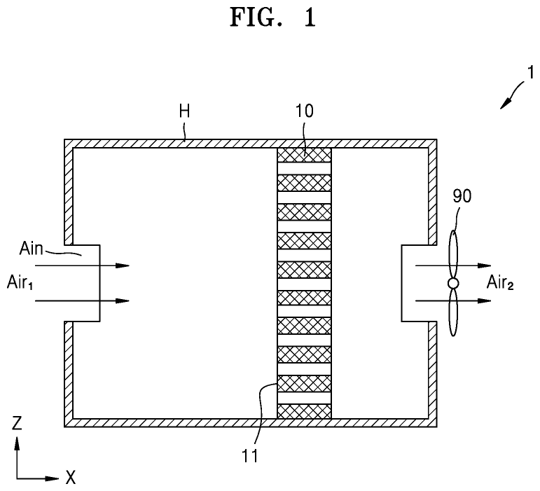

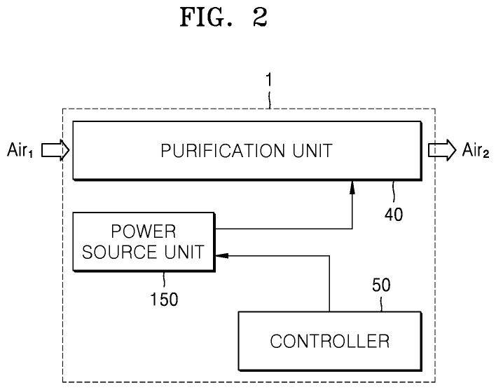

FIG. 1 is a schematic diagram of an air purifier according to an embodiment. FIG. 2 is a block diagram of an air purifier according to an embodiment.

Referring to FIGS. 1 and 2, an air purifier 1 according to an embodiment may include an air inlet Aᵢₙ through which polluted air Air₁ is introduced, a hollow reaction device H extending in a first direction X, an purification unit 10 that purifies the polluted air Air₁ into purified air Air₂, a controller 50 that controls driving of the air purifier 1, and an a pressure application device 90 that is arranged at a rear end of the air purifier 1 and applies pressure to move the polluted air Air₁.

Herein, the polluted air Air₁ may mean a mixed gas including air and one or more of a particulate matter (PM), a water-soluble organic compound, and a water-insoluble organic compound. In an embodiment, for example, the PM may include a small PM having a size (e.g., a diameter) of about 10 micrometers (μm) or less and ultrafine dust having a size of about 2.5 μm or less. Moreover, the water-soluble organic compound, which is a volatile organic compound, may include a gas material removable by being collected in water or an aqueous solution, e.g., ammonia (NH₃), acetaldehyde (CH₃CHO), and acetic acid (CH₃COOH). The water-insoluble organic compound, which is a volatile organic compound not collected in water or an aqueous solution, may include, for example, benzene (C₆H₆), formaldehyde (CH₂O), toluene (C₆H₅CH₃), etc. However, the disclosure is not limited thereto, such that other random gases than the PM, water-soluble organic compound, and the water-insoluble organic compound may be included in the polluted air Air₁. From the polluted air Ain introduced through the air inlet Aᵢₙ, a component that may be a problem for (or not suitable for an operation of) the purification unit 10, such as a particulate material, etc., may be removed by a pretreatment means or a pretreatment device (not shown). The pretreatment means or a pretreatment device (not shown) generally includes a means for removing (or a device configured to remove) a coarse particle, a particulate particle, and a chemical material, and thus a volatile organic compound may be included in the polluted air Air₁ introduced through the air inlet Aᵢₙ.

The air inlet Aᵢₙ may be a path through which the polluted air Air₁ may enter. According to an embodiment, the air inlet Aᵢₙ may be defined or arranged in the form of an opening at a front end of a reactor. However, the disclosure is not limited thereto, such that the air inlet Aᵢₙ may be arranged in the form of an opening at a random position at a front end of the purification unit 10. In an embodiment, for example, a pump (not shown) may be arranged in the air inlet Aᵢₙ to form negative pressure such that the polluted air Air₁ may be introduced through the air inlet Aᵢₙ.

In an embodiment, as shown in FIG. 1, where the air inlet Aᵢₙ and the purification unit 10 are sequentially arranged to communicate with each other, the pressure application device 90, e.g., a blower, may be arranged at a rear end of the reaction device H. Thus, by applying negative pressure to the inside of the reaction device H along the first direction X, the polluted air Air₁ and the purified air Air₂ may move along the air inlet Aᵢₙ and the purification unit 10.

The purification unit 10 may remove a pollutant included in the polluted air Air₁, e.g., a volatile organic compound and discharge the purified air Air₂. The purification unit 10 according to an embodiment may be arranged to be fixed inside the reaction device H. In an embodiment, for example, the purification unit 10 may include an opposing surface 11 perpendicular to the first direction X in which the polluted air Air₁ moves. In this case, the polluted air Air₁ may move to the rear end of the reaction device H by passing through the opposing surface 11.

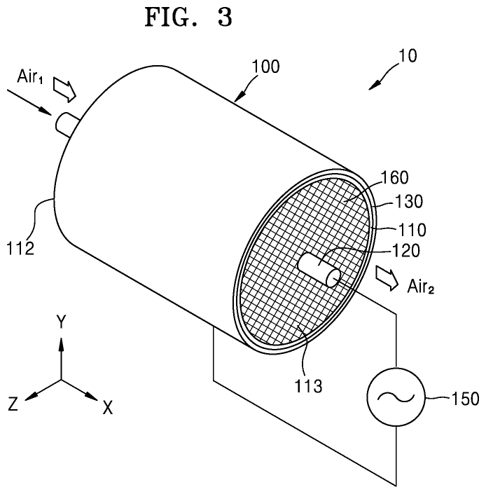

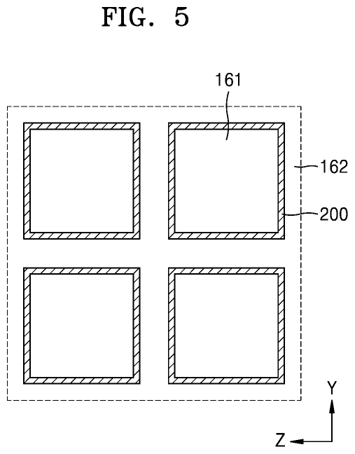

The purification unit 10 according to an embodiment may include a plasma reaction device 100 (shown in FIG. 3) and a catalyst 200 (shown in FIG. 5) to be described later to remove a pollutant included in the polluted air Air₁. Thus, when the polluted air Air₁ moves through the opposing surface 11, the pollutant included in the polluted air Air₁ may be removed. A technical feature of removing the pollutant included in the polluted air Air by using the purification unit 10 will hereinafter be described in detail with reference to FIGS. 3 to 9.

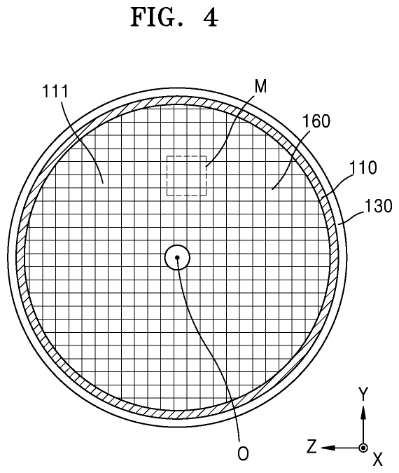

FIG. 3 is a schematic perspective view of a purification unit according to an embodiment. FIG. 4 is a front view of the purification unit shown in FIG. 3. FIG. 5 is an enlarged view of a region M shown in FIG. 4.

Referring to FIGS. 3 to 5, the purification unit 10 according to an embodiment may include the plasma reaction device 100 and the catalyst 200. In an embodiment, for example, the plasma reaction device 100 may include a reactor 110 through which the polluted air Air₁ passes, a first electrode unit 120, a second electrode unit 130, a power source unit 150 which applies a certain voltage between the first electrode unit 120 and the second electrode unit 130, and a support 160 arranged between the first electrode unit 120 and the second electrode unit 130.

The reactor 110 may have a tubular shape extending in the first direction (an X direction) and including (or defining) a hollow region 111 in which the polluted air Aᵢₙ may move. However, the shape of the reactor 110 is not specially limited, and for example, a cross-sectional shape of a plane (a YZ plane) perpendicular to the first direction (the X direction) of the reactor 110 may be various such as a circular shape, a polygonal shape, etc. The cross-sectional shape of the reactor 110 according to an embodiment may be a circular shape. In an embodiment, for example, the reactor 110 may be provided as a ceramic pipe or an aluminum pipe extending in one direction. However, the disclosure is not limited thereto, and any hollow pipe capable of generating discharge plasma may also be used as the reactor 110.

The reactor 110 according to an embodiment may form a flow path of the polluted air Air₁. Moreover, a dielectric material of a certain permittivity may be arranged in a hollow region 111 of the reactor 110. In such an embodiment, discharge plasma may be generated using the first electrode unit 120 and the second electrode unit 130 to be described later may be generated in the hollow region 111.

The first electrode unit 120, which is a power electrode, may extend in one direction. According to an embodiment, the first electrode unit 120 may include a rod shape extending in the first direction (the X direction). The first electrode unit 120 may include a certain cross-sectional shape along one plane (the YZ plane) perpendicular to the first direction (the X direction). In an embodiment, for example, the first electrode unit 120 may include a cross-sectional shape of a circular shape or a polygonal shape.

According to an embodiment, the first electrode unit 120 may include a metal material extending in the first direction (the X direction). In an embodiment, for example, the first electrode unit 120 may be provided as or defined by a stainless (SUS) wire extending in the first direction (the X direction) and may be arranged to be inserted into the hollow region 111 of the reactor 110. However, the disclosure is not limited thereto, and the first electrode unit 120 may include any electrode structure connected to the power source unit 150 to apply a high voltage. The first electrode unit 120 may be arranged in a central portion or a center O as shown in FIG. 4. In an embodiment, for example, where the reactor 110 has a circular-shape cross-section along a plane (the YZ plane) perpendicular to the first direction (the X direction), the first electrode unit 120 may be arranged in a central portion of the reactor 110, e.g., the central portion or the center O of the circular shape. Thus, a separating distance between the first electrode unit 120 and the second electrode unit 130 described below may be constant, such that relatively uniform discharge plasma may be formed.

In an embodiment, the second electrode unit 130 may be arranged to surround the first electrode unit 120. Moreover, the second electrode unit 130 may be arranged to be separated from the first electrode unit 120 by a certain space therebetween. The second electrode unit 130 according to an embodiment may be a ground electrode, and a discharge region thereof where the discharge plasma is generated may be surrounded by the second electrode unit 130.

In an embodiment, for example, the second electrode unit 130 may be integrated with the reactor 110 when the reactor 110 is a conductor. In an embodiment, for example, where the reactor 110 is an aluminum pipe, the second electrode unit 130 may be integrated (or integrally formed) with the reactor 110 to be replaced with the reactor 110. In an embodiment where the reactor 110 is a nonconductor, the second electrode unit 130 may be in the shape of a thin metal film or plate provided to surround an outer wall of the reactor 110. In an embodiment, for example, where the reactor 110 is a ceramic pipe, the second electrode unit 130 may be in the shape of a thin aluminum plate or an aluminum thin film provided to surround the outer wall of the reactor 110.

The power source unit 150 may apply a high voltage to the discharge region where the discharge plasma is generated. In an embodiment, for example, the power source unit 150 may apply a certain voltage between the first electrode unit 120 and the second electrode unit 130 to generate plasma between the first electrode unit 120 and the second electrode unit 130. The power source unit 150 according to an embodiment may include a sinusoidal alternating current (AC) power supply device and a transformer. The power source unit 150 may consistently apply a high voltage to the inside of the reactor 110, e.g., the discharge region where the discharge plasma is generated, through an electric system described above. In an embodiment, for example, a voltage applied to the discharge region may be about 2 kilovolts (kV) or greater and about 500 KV or less, and a frequency may be about 10 hertz (Hz) or greater and about 1000 Hz or less, but the disclosure is not limited thereto. In the discharge region, the separating distance between the first electrode unit 120 and the second electrode unit 130 may be about 10 millimeters (mm) or greater and about 100 mm or less, such that an electric field of about 2 kilovolts per centimeter (kV/cm) or greater and about 5 kV/cm or less may be applied in the discharge region.

The support 160 may be arranged in the discharge region formed between the first electrode unit 120 and the second electrode unit 130. In an embodiment, for example, the support 160 may include a dielectric material having a certain permittivity. In an embodiment, for example, the support 160 may include one or more of (or at least one selected from) a metal oxide, a metal nitride, and a high-molecular polymer. In an embodiment where the reactor 110 is implemented with a nonconductor, e.g., a ceramic pipe according to an embodiment, the support 160 including ceramic may be integrated or integrally formed with the reactor 110 as a single unitary and indivisible part. However, the disclosure is not limited thereto, and in an embodiment where the reactor 110 is implemented with a conductor, e.g., an aluminum pipe or includes a material that is different from that of the support 160, the reactor 110 and the support 160 may be separate structures and may not be formed integrally with each other.

In an embodiment, for example, the support 160 may be provided with a plurality of through-holes 161 extending in the first direction (the X direction). In an embodiment, for example, the plurality of through-holes 161 may be defined to extend from a front end 112 of the reactor 110 to a rear end 113 of the reactor 110. Thus, a plurality of flow paths may be formed to extend from the front end 112 of the reactor 110 to the rear end 113 of the reactor 110. In an embodiment, for example, the polluted air Air₁ introduced to the front end 112 of the reactor 110 may move to the rear end 113 of the reactor 110 along the plurality of through-holes 161.

According to an embodiment, as the support 160 includes the plurality of through-holes 161, a pressure difference between the front end 112 of the reactor 110 and the rear end 113 of the reactor 110, i.e., a differential pressure between the front end 112 of the reactor 110 and the rear end 113 of the reactor 110 may be reduced. In an embodiment, for example, where a dielectric material is filled in the form of a pellet or powder in the discharge region of the reactor 110, i.e., between the first electrode unit 120 and the second electrode unit 130, a diameter of a flow path through which the polluted air Air₁ may pass may not be sufficiently secured. In an embodiment, where the dielectric material in the form of a pellet or powder is filled between the first electrode unit 120 and the second electrode unit 130, the flow path may be provided in the shape of a curve rather than a straight line, thereby increasing a length of the flow path through which the polluted air Air₁ passes. Thus, when the polluted air Air₁ of a same flow rate is introduced to the front end 112 of the reactor 110, a differential pressure between the front end 112 of the reactor 110 and the rear end 113 of the reactor 110 may be more reduced when the plurality of through-holes 161 are arranged in the discharge region of the reactor 110 than a case where the dielectric material in the form of a pallet or powder is filled in the discharge region of the reactor 110.

According to an embodiment, the differential pressure between the front end 112 of the reactor 110 and the rear end 113 of the reactor 110 may be about 10 pascals (Pa) or greater and about 1,000 Pa or less. However, the disclosure is not limited thereto, and the differential pressure between the front end 112 of the reactor 110 and the rear end 113 of the reactor 110 may be set differently according to a purpose of use of the air purifier 1.

In an embodiment, for example, the differential pressure between the front end 112 of the reactor 110 and the rear end 113 of the reactor 110 may be adjusted based on an arrangement density of the plurality of through-holes 161 and a cross-sectional area along a plane (the YZ plane) perpendicular to the first direction (the X direction). A time for which the polluted air Air₁ remains in the reactor 110 may be controlled based on the arrangement density of the plurality of through-holes 161 and the cross-sectional area along the plane (the YZ plane) perpendicular to the first direction (the X direction). In an embodiment, for example, as a ratio of a cross-sectional area of the plurality of through-holes 161 to a circular cross-sectional area of the reactor 110 along the plane (the YZ plane) perpendicular to the first direction (the X direction) increases, the differential pressure between the front end 112 of the reactor 110 and the rear end 113 of the reactor 110 may be reduced. A time for which the polluted air Air₁ remains in the reactor 110 may be reduced.

According to an embodiment, the support 160 may have a honeycomb structure with the plurality of through-holes 161 extending in the first direction (the X direction). A cross-sectional shape of the plurality of through-holes 161 along a plane (the YZ plane) perpendicular to the first direction (the X direction) may include one or more of a polygonal shape and a circular shape. In an embodiment, for example, the plurality of through-holes 161 may have a rectangular cross-section along a plane (the YZ plane) perpendicular to the first direction (the X direction) as shown in FIG. 5. However, the disclosure is not limited thereto, and the plurality of through-holes 161 may have a random cross-sectional shape through which the polluted air Air₁ may pass.

The catalyst 200 may be coated along a surface of the support 160 to remove the pollutant included in the polluted air Air₁. In an embodiment, for example, the catalyst 200 may include one or more of titanium (Ti), aluminum (Al), zinc (Zn), copper (Cu), magnesium (Mg), silicon (Si), nickel (Ni), platinum (Pt), rhodium (Rh), argentum (Ag), ruthenium (Ru), or an oxide thereof. However, the disclosure is not limited thereto, and the catalyst 200 may include a random catalytic material capable of removing the pollutant included in the polluted air Air₁.

The catalyst 200 according to an embodiment may be combined with plasma generated in the plasma reaction device 100. In an embodiment, for example, when active species generated in the plasma act on the catalyst 200, a volatile organic compound decomposition catalyst acting at a high temperatures of 200 degrees Celsius or higher may act at a room temperature. Thus, the catalyst 200 may decompose a volatile organic compound with high efficiency. Here, the room temperature may be in a range of about 15 degrees Celsius to about 25 degrees Celsius, e.g., about 20 degrees Celsius, in a range of about 20 degrees Celsius to about 25 degrees Celsius, in a range of about 20 degrees Celsius to about 22 degrees Celsius, or in a range of about 21 degrees Celsius to about 23 degrees Celsius.

The time for which the plasma generated in the plasma reaction device 100 remains is generally substantially short in nanoseconds to microseconds. Thus, a time for which the catalyst 200 may act with the plasma may also be very short from nanoseconds to microseconds. According to an embodiment, the plasma may be generated in a reaction region formed between the first electrode unit 120 and the second electrode unit 130. The support 160 may be arranged between the first electrode unit 120 and the second electrode unit 130, and the catalyst 200 may be arranged to coat the surface of the support 160. Thus, the catalyst 200 may be arranged in the reaction region generated in the plasma, i.e., between the first electrode unit 120 and the second electrode unit 130, such that the catalyst 200 may be combined with the plasma simultaneously with generation of the plasma. Thus, the catalyst 200 according to an embodiment may decompose the volatile organic compound included in the polluted air Air₁ at high efficiency by being combined with the plasma.

In an embodiment, as described above, the catalyst 200 may be arranged to coat the surface of the support 160. In an embodiment, for example, when the support 160 includes the plurality of through-holes 161 as shown in FIG. 5, the catalyst 200 may be coated along the surfaces of the plurality of through-holes 161. In an embodiment, for example, where the support 160 has a honeycomb structure including the plurality of through-holes 161, the catalyst 200 may be arranged along a sidewall of a honeycomb structure 162 forming the plurality of through-holes 161. However, the disclosure is not limited thereto, and the catalyst 200 may be arranged at a random location on the surface of the support 160 arranged in the reaction region where the plasma is generated.

The catalyst 200 according to an embodiment may include one or more of materials having a permittivity in a range of 3 to 2,500. In an embodiment, for example, the catalyst 200 may include at least one selected from barium (Ba) and Ti. In an embodiment, for example, where a material having a relatively high permittivity is arranged in the discharge region between the first electrode unit 120 and the second electrode unit 130, an electric field between the first electrode unit 120 and the second electrode unit 130 may increase and a temperature of electrons generated in the first electrode unit 120 or a temperature of electrons generated in a gas around the first electrode unit 120 may increase. Thus, a temperature of a plasma discharge region formed between the first electrode unit 120 and the second electrode unit 130 may relatively increase. Therefore, when the catalyst 200 arranged in the plasma discharge region formed between the first electrode unit 120 and the second electrode unit 130 acts at a high temperature, the volatile organic compound may be decomposed at a high efficiency.

The catalyst 200 according to an embodiment may include one or more of materials having an electrical conductivity of about 10⁻⁶ Siemes per centimeter (S/cm) or less. In an embodiment, for example, the catalyst 200 may include at least one selected from Ni, Pt, Rh, Ag, and Ba. In an embodiment, for example, where a dielectric material including a relatively high electrical conductivity is arranged in the discharge region between the first electrode unit 120 and the second electrode unit 130, the uniformity of the plasma may be increased in the plasma discharge region between the first electrode unit 120 and the second electrode unit 130. Thus, the catalyst 200 arranged in the plasma discharge region formed between the first electrode unit 120 and the second electrode unit 130 acts at a high temperature by being uniformly combined with the plasma, thereby decomposing the volatile organic compound included in the polluted air Air₁ at a high efficiency.

### Experimental Example

At atmospheric pressure and near-room temperature, purification reaction of the polluted air Air₁ using the air purifier 1 is performed.

The polluted air Air₁ introduced to the front end 112 of the reactor 110 includes toluene of about 10 parts per million (ppm), and a volume flow rate of the polluted air Air₁ is about 50 liters per minute (L/min). As a dielectric barrier of the reactor 110, a ceramic pipe having an inner diameter of about 69 mm and a thickness of about 2 mm is used. A stainless steel rod having a diameter of about 0.5 mm may be used as the first electrode unit 120 (a power electrode), and an aluminum thin film is used as the second electrode unit 130 (a ground electrode). A discharge region having a length of about 50 mm in the reactor 110 is surrounded by the ground electrode. A discharge gap between an inner surface of the ceramic pipe and a high-voltage electrode, which is the first electrode unit 120, is about 33.5 mm. The support 160 provided in the plasma discharge region includes a honeycomb structure of a ceramic material. The support 160 may include the plurality of through-holes 161 of 300 cell per square inch (cpsi). The Hopcalite catalyst 200 is coated on the surface of the support 160. A sinusoidal AC power supply device is connected to a transformer, and a high voltage is continuously applied to a plasma discharge region through this electric system. The voltage applied to the plasma discharge region is 20 kV. In the purified air Air₂ discharged to the rear end 113 of the reactor 110, the remaining rate of toluene is measured. Moreover, a differential pressure between the front end 112 and the rear end 113 of the reactor is measured.

### Comparative Example 1

Components are the same as those in Experimental Example except that the support 160 of the honeycomb structure having the catalyst 200 coated on the surface thereof is arranged continuously from the rear end of the plasma reaction device 100 instead of arranging the support 160 between the first electrode unit 120 and the second electrode unit 130.

### Comparative Example 2

Components are the same as those in Experimental Example except that the Hopcalite catalyst 200 having a length of 3 mm in the form of a pallet is arranged instead of arranging the support 160 between the first electrode unit 120 and the second electrode unit 130.

It may be seen that in Experimental Example, the concentration of toluene in the purified air Air₂ is reduced to 2.5 ppm, thus removing 75% of the toluene. In addition, a differential pressure between the front end 112 and the rear end 113 of the reactor 110 is 30 Pa.

It may be seen that in Comparative Example 1, the concentration of toluene in the purified air Air₂ is reduced to 5.5 ppm, thus removing 45% of the toluene. In addition, a differential pressure between the front end 112 and the rear end 113 of the reactor 110 is 35 Pa.

It may be seen that in Comparative Example 2, the concentration of toluene in the purified air Air₂ is reduced to 2.5 ppm, thus removing 75% of the toluene. In addition, a differential pressure between the front end 112 and the rear end 113 of the reactor 110 is 352 Pa.

Comparing Experimental Example with Experimental Example 1, it may be seen that when the support 160 provided with the plurality of through-holes 161 having the catalyst 200 coated therein is arranged in the plasma reaction region, a removal rate of toluene increases. That is, in Experimental Example where the catalyst 200 is combined simultaneously with generation of the plasma, the active species generated in the plasma act on the catalyst 200 for a short time, such that the efficiency of activation of the catalyst by the plasma increases.

Comparing Experimental Example with Comparative Example 2, when the support 160 including the plurality of through-holes 161 is arranged, the differential pressure between the front end 112 and the rear end 113 of the reactor 110 is reduced. Thus, it may be seen that the treatment efficiency of the large-volume polluted air Air₁ increases.

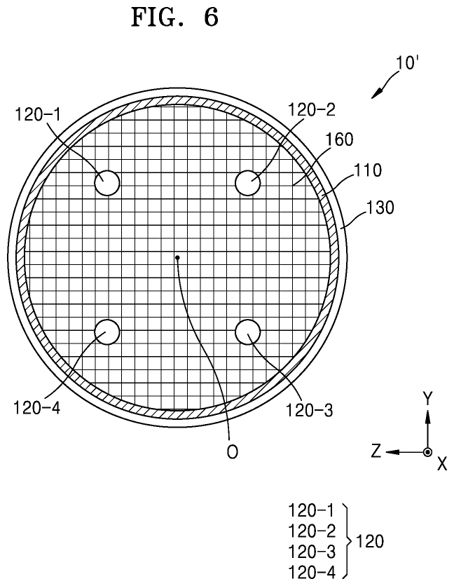

FIG. 6 is a front view of a purification unit according to an embodiment.

Referring to FIG. 6, an embodiment of a purification unit 10′ may include the plasma reaction device 100 and the catalyst 200. In an embodiment, for example, the plasma reaction device 100 may include a reactor 110 through which the polluted air Air₁ passes, a first electrode unit 120, a second electrode unit 130, a power source unit 150 which applies a certain voltage between the first electrode unit 120 and the second electrode unit 130, and a support 160 arranged between the first electrode unit 120 and the second electrode unit 130. The other components than the first electrode unit 120 are the same as those in FIGS. 3 to 5 and thus any repetitive detailed description thereof will be omitted.

The first electrode unit 120 according to an embodiment may be provided in plural. In an embodiment, for example, the plurality of first electrode units 120 may be arranged to be separated by a certain space therebetween along a plane (the YZ plane) perpendicular to the first direction (the X direction). According to an embodiment, the plurality of first electrode units 120 may be 4 electrode units. In an embodiment, for example, the plurality of first electrode unit 120 may include a first-first electrode unit 120-1, a first-second electrode unit 120-2, a first-third electrode unit 120-3, and a first-fourth electrode unit 120-4. The first-first electrode unit 120-1, the first-second electrode unit 120-2, the first-third electrode unit 120-3, and the first-fourth electrode unit 120-4 may be arranged symmetrically with respect to each other around the central portion (or central axis extending in X direction) O of the reactor 110. However, the disclosure is not limited thereto, such that the plurality of first electrode units 120 may be provided as a random number of two or more electrode units and may be arranged in a random region inside the reactor 110.

According to an embodiment, where the reactor 110 has a circular cross-section along a plane (the YZ plane) perpendicular to the first direction (the X direction), the first-first electrode unit 120-1, the first-second electrode unit 120-2, the first-third electrode unit 120-3, and the first-fourth electrode unit 120-4 may be arranged symmetrically with respect to each another around the central portion or center O of the circular cross-section of the reactor 110. In such an embodiment, as the plurality of first electrode units 120 are arranged symmetrically with respect to each other around the central portion or center O of the reactor 110, plasma may be generated uniformly in the plasma reaction region, e.g., between the plurality of first electrode units 120 and the second electrode unit 130.

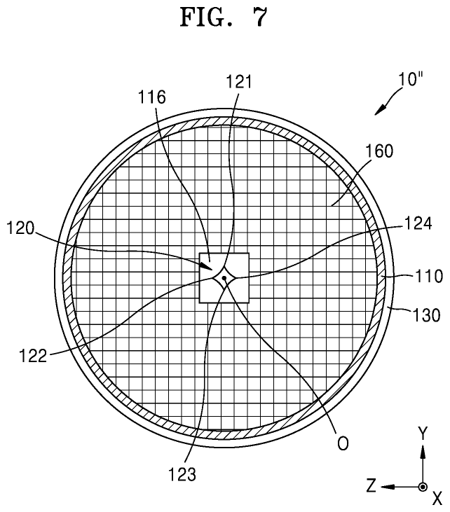

FIG. 7 is a front view of a purification unit according to an embodiment.

Referring to FIG. 7, an embodiment of a purification unit 10″ may include the plasma reaction device 100 and the catalyst 200. In an embodiment, for example, the plasma reaction device 100 may include a reactor 110 through which the polluted air Air₁ passes, a first electrode unit 120, a second electrode unit 130, a power source unit 150 which applies a certain voltage between the first electrode unit 120 and the second electrode unit 130, and a support 160 arranged between the first electrode unit 120 and the second electrode unit 130. The other components than the first electrode unit 120 are the same as those in FIGS. 3 to 5 and thus any repetitive detailed description thereof will be omitted.

The first electrode unit 120 according to an embodiment, which is a power electrode, may extend in one direction. According to an embodiment, the first electrode unit 120 may include a rod shape extending in the first direction (the X direction). The first electrode unit 120 may have a certain cross-sectional shape along one plane (the YZ plane) perpendicular to the first direction (the X direction). In an embodiment, for example, the first electrode unit 120 may have a cross-sectional shape of a circular shape or a polygonal shape.

In an embodiment, as described above, the first electrode unit 120 may have a certain cross-sectional shape along a plane (the YZ plane). In such an embodiment, the cross-sectional shape of the first electrode unit 120 may have a shape symmetrical to each other from the center. In an embodiment, for example, as shown in FIG. 4, the first electrode unit 120 may have a circular cross-section symmetrical from the center. In an alternative embodiment, for example, as shown in FIG. 7, the first electrode unit 120 may have a polygonal cross-section symmetrical from the center. In such an embodiment, the first electrode unit 120 may be arranged to be inserted into a perforated region 116 provided in the central portion or center of the reactor 110.

According to an embodiment, when the first electrode unit 120 includes a polygonal cross-section symmetrical from the center, the first electrode unit 120 may be arranged symmetrically with respect to each other around the central portion or center O of a circular cross-sectional portion of the reactor 110. In an embodiment, for example, a first corner 121 to a fourth corner 124 included in the first electrode unit 120 may be arranged symmetrically with respect to each other around the central portion or center O of the circular cross-sectional portion of the reactor 110. As the polygonal cross-section of the first electrode unit 120 is arranged symmetrically around the central portion or center O of the reactor 110, plasma may be generated uniformly in the plasma reaction region, e.g., between the first electrode unit 120 and the second electrode unit 130.

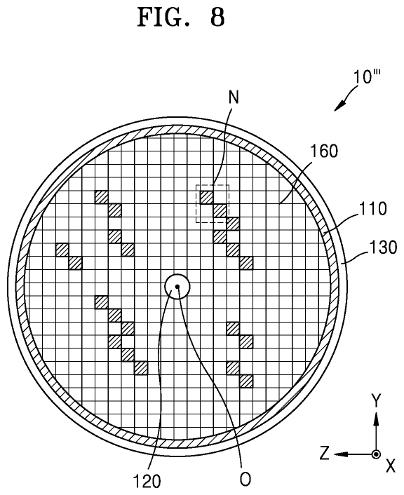

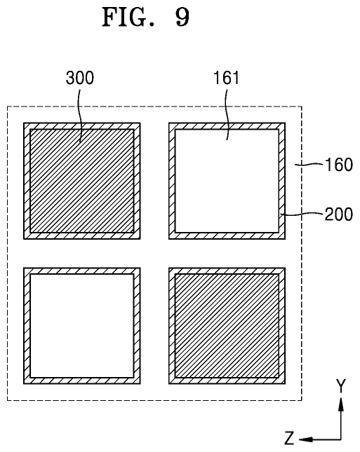

FIG. 8 is a front view of a purification unit according to an embodiment. FIG. 9 is an enlarged view of a region N shown in FIG. 8.

Referring to FIGS. 8 and 9, an embodiment of a purification unit 10″ may include the plasma reaction device 100 and the catalyst 200. In an embodiment, for example, the plasma reaction device 100 may include a reactor 110 through which the polluted air Air passes, a first electrode unit 120, a second electrode unit 130, a power source unit 150 which applies a certain voltage between the first electrode unit 120 and the second electrode unit 130, and a support 160 arranged between the first electrode unit 120 and the second electrode unit 130. The other components than the support 160 are the same as those in FIGS. 3 to 5 and thus any repetitive detailed description thereof will be omitted.

The support 160 according to an embodiment may include a plurality of through-holes 161 extending in the first direction (the X direction). In an embodiment, for example, the plurality of through-holes 161 may extend from a front end 112 of the reactor 110 to a rear end 113 of the reactor 110. Thus, a plurality of flow paths may be formed to extend from the front end 112 of the reactor 110 to the rear end 113 of the reactor 110. In an embodiment, for example, the polluted air Air₁ introduced to the front end 112 of the reactor 110 may move to the rear end 113 of the reactor 110 along the plurality of through-holes 161.

According to an embodiment, one or more filter units 300 may be arranged in one or more of the plurality of through-holes 161 arranged in the support 160. In an embodiment, for example, one or more filter units 300 may be ceramic filters, but the disclosure is not limited thereto. As the filter unit 300 is arranged in one or more of the plurality of through-holes 161, a pollutant included in the polluted air Air₁ introduced to the front end 112 of the reactor 110 may be removed by one or more filter units 300. As the filter unit 300 is arranged in one or more of the plurality of through-holes 161, a pressure difference between the front end 112 of the reactor 110 and the rear end 113 of the reactor 110, i.e., a differential pressure between the front end 112 of the reactor 110 and the rear end 113 of the reactor 110 may be increased in comparison to when one or more filter units 300 are not arranged. However, when a pre-treatment purifying process for the polluted air Air₁ introduced to the front end 112 of the reactor 110 is not performed or a differential pressure between the front end 112 of the reactor 110 and the rear end 113 of the reactor 110 is not large due to a relatively small flow rate of the polluted air Air₁, then the polluted air Air₁ may be further purified through the one or more filter units 300.

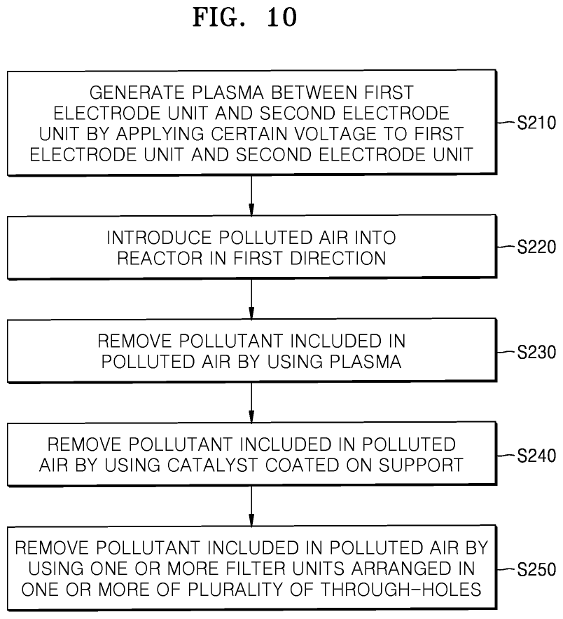

FIG. 10 is a flowchart of an air purifying method according to an embodiment.

Referring to FIG. 10, according to an embodiment, by applying a certain voltage to the first electrode unit 120 and the second electrode unit 130, plasma may be generated between the first electrode unit 120 and the second electrode unit 130, in operation S210. In an embodiment, for example, the second electrode unit 130 may be arranged as a ground electrode on an outer wall portion of the reactor 110, and the first electrode unit 120 may be arranged as a power electrode inside the reactor 110. In such an embodiment, the first electrode unit 120 and the second electrode unit 130 may be arranged to be separated from each other by a certain space therebetween. By applying a certain voltage to the first electrode unit 120 and the second electrode unit 130, the plasma may be generated in the support 160. In such an embodiment, the catalyst 200 coated on the support 160 may be combined with the plasma active species.

Next, the polluted air Air₁ may be introduced into the reactor 110 in the first direction (the X direction) in operation S220. In an embodiment, for example, the polluted air Air₁ may be a mixed gas including the pollutant, e.g., the volatile organic compound. The volume flow rate of the polluted air Air₁ introduced may be adjusted based on the differential pressure between the front end 112 of the reactor 110 and the rear end 113 of the reactor 110.

Next, by using the plasma, the pollutant included in the polluted air Air₁ may be removed in operation S230. In an embodiment, for example, the plasma may be formed between the first electrode unit 120 and the second electrode unit 130, and the polluted air Air₁ may move through the plurality of through-holes 161 included in the support 160 arranged between the first electrode unit 120 and the second electrode unit 130. In a process where the polluted air Air₁ moves through the plurality of through-holes 161, the pollutant included in the polluted Air₁ may be removed by the plasma.

Next, by using the catalyst 200 coated on the support 160, the pollutant included in the polluted air Air₁ may be removed in operation S240. In an embodiment, for example, the catalyst 200 coated on the support 160 may be combined with the plasma simultaneously with generation of the plasma. Thus, the active species generated in the plasma may act for a short time, thereby increasing the activation efficiency of the catalyst by the plasma. By using the activated catalyst 200, the pollutant included in the polluted air Air₁ may be removed.

Next, the pollutant included in the polluted air Air₁ may be removed by using one or more filter units arranged in one or more of the plurality of through-holes, in operation S250. According to an embodiment, one or more filter units 300 may be arranged in one or more of the plurality of through-holes 161 arranged in the support 160. As the filter unit 300 is arranged in one or more of the plurality of through-holes 161, a pollutant included in the polluted air Air₁ introduced to the front end 112 of the reactor 110 may be removed by one or more filter units 300. When a pre-treatment purifying process for the polluted air Air₁ introduced to the front end 112 of the reactor 110 is not performed or a differential pressure between the front end 112 of the reactor 110 and the rear end 113 of the reactor 110 is not large due to a relatively small flow rate of the polluted air Air₁, then the polluted air Air₁ may be further purified through the one or more filter units 300.

While the air purifier and the method of purifying air according to embodiments have been shown and described in connection with the embodiments to help understanding of the disclosure, it will be apparent to those of ordinary skill in the art that modifications and variations may be made. Therefore, the true technical scope of the disclosure should be defined by the appended claims.

In the air purifier and the method of purifying air according to embodiments, the active species generated in the plasma may act on the catalyst, such that the volatile organic compound decomposition catalyst acting at a room temperature may purify the polluted air.

In such embodiments, the active species generated in the plasma may act for a short time, thereby increasing the activation efficiency of the catalyst by the plasma.

In such embodiments, there are provided the air purifier and the method of purifying air in which the differential pressure between the front end and the rear end of the plasma reactor may be reduced.

In such embodiments, there may be provided the air purifier and the method of purifying air in which the differential pressure between the front end and the rear end of the plasma reactor may be reduced to purify a large flow rate of polluted air.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. An air purifier comprising:
a reactor in a tubular shape defining a hollow region extending in a first direction;
a first electrode unit extending in the first direction and arranged in the hollow region;
a second electrode unit arranged to surround the first electrode unit and separated from the first electrode unit with a certain space therebetween;
a power source unit which applies a certain voltage between the first electrode unit and the second electrode unit to generate plasma between the first electrode unit and the second electrode unit;
a support arranged between the first electrode unit and the second electrode unit, wherein a plurality of through-holes extending in the first direction is defined through the support; and
a catalyst coated on a surface of the support defining the plurality of through-holes.

2. The air purifier of claim 1, wherein the support has a honeycomb structure.

3. The air purifier of claim 1, wherein a differential pressure between a front end of the reactor and a rear end of the reactor is greater than or equal to about 10 Pa and less than or equal to about 1,000 Pa.

4. The air purifier of claim 1, wherein the catalyst comprises at least one selected from titanium (Ti), aluminum (Al), zinc (Zn), copper (Cu), magnesium (Mg), silicon (Si), nickel (Ni), platinum (Pt), rhodium (Rh), argentum (Ag), ruthenium (Ru), and an oxide thereof.

5. The air purifier of claim 1, wherein the catalyst comprises a material having a permittivity greater than or equal to about 3 and less than or equal to about 2,500.

6. The air purifier of claim 1, wherein the catalyst comprises a material having an electrical conductivity of about 106 S/cm or less.

7. The air purifier of claim 1, wherein the support comprises at least one selected from a metal oxide, a metal nitride, and a high-molecular polymer.

8. The air purifier of claim 1, wherein the reactor and the support are formed integrally with each other as a single unitary and indivisible part.

9. The air purifier of claim 1, wherein
the reactor has a cross-section in a circular shape along a plane perpendicular to the first direction, and
the first electrode unit is arranged in a center of the circular shape.

10. The air purifier of claim 1, wherein
the first electrode unit comprises a steel wire arranged in the hollow region of the reactor, and
the second electrode unit comprises an aluminum plate arranged on an outer wall portion of the reactor.

11. The air purifier of claim 1, wherein the first electrode unit is provided in plural, and a plurality of first electrode units is arranged to be separated from one another with a certain space therebetween along a plane perpendicular to the first direction.

12. The air purifier of claim 11, wherein
the reactor has a cross-section in a circular shape along a plane perpendicular to the first direction, and
the plurality of first electrode units is arranged symmetrically with respect to each other around a center of the circular shape.

13. The air purifier of claim 1, wherein the first electrode unit has a cross-section in a circular shape along a plane perpendicular to the first direction.

14. The air purifier of claim 1, wherein the first electrode unit has a cross-section in a polygonal shape along a plane perpendicular to the first direction.

15. The air purifier of claim 14, wherein the reactor has a cross-section in a circular shape along a plane perpendicular to the first direction, and
the first electrode unit is arranged such that the polygonal shape is symmetric around a central portion of the circular shape.

16. The air purifier of claim 1, further comprising:
one or more filter units arranged in one or more of the plurality of through-holes, respectively.

17. An operating method of the air purifier according to claim 1, the operating method comprising:
forming plasma between the first electrode unit and the second electrode unit by applying a certain voltage to the first electrode unit and the second electrode unit;
moving polluted air to a reactor in the first direction;
removing a pollutant included in the polluted air by using the plasma; and
removing the pollutant included in the polluted air by using the catalyst coated on the support.

18. The operating method of claim 17, further comprising:
removing the pollutant included in the polluted air by using one or more filter units arranged in one or more of the plurality of through-holes, respectively.

19. The operating method of claim 17, wherein the support has a honeycomb structure.

20. The operating method of claim 17, wherein the catalyst comprises at least one selected from titanium (Ti), aluminum (AI), zinc (Zn), copper (Cu), magnesium (Mg), silicon (Si), nickel (Ni), platinum (Pt), rhodium (Rh), argentum (Ag), ruthenium (Ru), and an oxide thereof.
